(19) United States
(12) Patent Application Publication
(10) Pub. No.: US 2012/0052170 A1
(43) Pub. Date: Mar. 1, 2012

(54) PROCESS FOR INFUSING RAWHIDE WITH COLOR, FLAVOR OR OTHER AGENTS

(76) Inventor: Jianrong (Janet) Zhang, Reston, VA (US)

(21) Appl. No.: 13/017,113

(22) Filed: Jan. 31, 2011

Related U.S. Application Data
(60) Provisional application No. 61/376,745, filed on Aug. 25, 2010.

(51) Int. Cl. A23K 1/00

(52) U.S. Cl. 426/250; 426/281; 426/254

(57) ABSTRACT

An improved method for infusing or marinating a rawhide product with additives such as color and/or flavor is provided. In the method, the animal hide is infused with additives such as flavor and/or color during the washing process. The additives permeate the interior of the hide after first opening the pore structure of the hide by altering the pH, then closing the pores in order to trap the additives. The additives are entrapped, thereby preventing release when moisture is applied.

This application claims priority benefit of U.S. Provisional Patent Application No. 61/376,745 filed Aug. 25, 2010.

### BACKGROUND OF THE INVENTION

Rawhide is given to dogs to encourage chewing to remove tartar from the teeth, as well as to keep the dog occupied. Traditional rawhide processing produces a final product that is both unflavored as well as a natural, creamy white appearance. The natural rawhide does not stain carpets or fur.

In order to increase palatability, the natural dried rawhide is dipped into a flavor solution that is colored to “match” the flavor. For example, beef flavored rawhide is dipped into a solution containing beef flavor and caramel color and other coloring for a beef-like color.

Although palatability is enhanced, the color solution creates a problem for the consumer as the color solution rubs off from rawhide once the dog starts to chew. This color solution can permanently stain carpet and furniture, as well as the fur of light colored dogs. In addition, cost of the rawhide is now increased, as the rawhide is processed a second time because the dried rawhide is coated with the solution and must be dried again to drive off the moisture in the coating so the rawhide does not mold.

In addition, palatability enhancement is temporary as the dog can easily lick the solution off the surface of the rawhide and bring it back to its natural state. This is because the flavor is merely sitting on the surface of the hide and not dispersed throughout.

In the prior art, there is a method for infusing a flavor and/or color into an animal hide in order to make a produced animal chew more attractive to animals is described. The method includes infusing a clean hide product with “sufficient” flavoring (typically approximately 2% to get desired palatability) and coloring (typically approximately 2% to get desired color of finished good) materials using a bath or slurry; a bath of flavoring and coloring is initially prepared into which a fully cleaned animal hide is introduced and mixed for at least two hours in order to allow the flavor and color ingredients to thoroughly infuse the hide. This process, while advantageous, is less than desirable because the processing time for infusion is far longer than desired. More specifically, the prior art adds an additional step following the hide going through a typical washing and cleaning process, thus requiring at least two hours for the infusion process, and therefore making it more costly to produce a finished product. As can be appreciated, at least two hours are required to achieve the desired final color of the rawhide and to assure that the flavor and color has “sufficient” time to penetrate the hide. This long soaking time (as well as a high concentration of color and flavor) are required because the hide has gone through the entire cleaning process before the color and flavor are introduced.

Accordingly, it would be desirable to provide an improved process for infusing an animal hide using a lower level of color, flavor and/or other agents in order to achieve improved agent dispersion and entrapment throughout the entire hide product over a shorter period of time.

### SUMMARY OF THE INVENTION

Generally speaking, in accordance with the invention, an improved method for infusing or marinating a rawhide product with additives such as color and/or flavor is provided. In the method, the animal hide is infused with additives such as flavor and/or color during the washing process, rather than after the washing process, as in the prior art. In addition, the additives permeate the interior of the hide faster after first opening the pore structure of the hide by altering the pH, then closing the pores in order to trap the additives. As a result, the additives are entrapped, thereby preventing release when moisture is applied.

For color and flavor additives, the end result is a hide product that has the color and flavor that it denotes.

Moreover, the inventive hide product does not stain carpet or fur and is highly flavorful, which encourages a dog or other animal to chew the rawhide until it is consumed.

Accordingly, it is an object of the invention to provide an improved process for infusing animal hide with one or more additives such as color and/or flavor agents.

Another object of the invention is to provide an improved animal hide infusing process in which an infused color or flavor is prevented from rubbing off or staining.

A further object of the invention is to provide an improved animal hide infusing process in which one or more additives are uniformly dispersed throughout the entire hide product.

Still other objects of the invention will be obvious and/or apparent from the following description.

### DETAILED DESCRIPTION OF THE INVENTION

It is important to note that the inventive process is preferably conducted in a rotating drum. The hide pieces are placed in the drum, and the solutions that are used are prepared separately and then added to the drum. Then the drum is rotated, after which it is opened to let the specific solution out. Then clean water is added to the drum to wash off any residue. After water washing, the next step in the process is carried out.

The inventive process improves upon prior art processes by adding one or more additives, such as color and/or flavor during the washing process, specifically after an acid solution is mixed with the hide, which causes the pores of the rawhide product to open. The additives then enter the pores via mechanical action during infusion. Timing is controlled, as well as the pH. At the end of the infusion step, the rawhide pores close, thus trapping the color and flavor throughout the rawhide. The rawhide is then formed and dried as per regular rawhide processing. The result is dried rawhide that has enhanced palatability with both flavor and/or color dispersed throughout. For color additives, as will be appreciated, the color is trapped in the pores, so when a dog or other animal chews, there is no color transfer from the rawhide to the carpet, furniture or even the fur of the animal.

In addition, since additives such as color and flavor are added during the normal washing processing of the hide, no extra step after washing and no extra dipping and drying process steps are needed and thus the process is much more efficient and less expensive than simply coating a rawhide product.

The inventive method of producing a hide product is now described. In general, a hide from a tannery, or other sources, is prepared and cleaned using a water and other solutions so that it can be used to make a hide product. This may include several processing steps, such as washing with water, de-liming, degreasing and bleaching. The hide is preferably cow hide, however, other hides can be used, including hides from beef, pigs, and other animals. Again, the hide is placed in a drum and the entire cleaning and infusion process takes place in this drum.

The first step of the process is liming. The liming process uses an alkali solution, such as a solution of calcium oxide or calcium hydroxide and water. The hide is soaked in a drum with this alkali solution. This achieves four objectives: removal of interfibrillary proteins from the hide, removal of keratin proteins from the hide, collagen swelling and collagen fiber bundle splitting. The alkalai solution is then drained from the drum. The hide is then rinsed with clean water to remove the liming solution.

The next step of the method is de-liming and should be carried out in a de-liming solution that is at a pH of between about 8 and 9. The de-liming process achieves two objectives: removal of alkali from the hide and the resultant de-swelling of the hide fibers, and lowering of the liquor pH. In the de-liming step, ammonium sulfate or ammonium chloride are mixed with water in order to form a de-liming solution. Sometimes a surfactant is added to the solution. The de-liming solution is then added to the drum and the rawhide is soaked in the de-liming solution. The de-liming process will remove the lime from the hide fibers, as well as the fat if there is any that still exists. Also, this process will reduce the surface tension on the hide. The solution is then drained and the hide is rinsed with clean water. The drum is then drained.

The next step of the process is bleaching, which is carried out in order to produce a lighter colored hide. In this step, a water and hydrogen peroxide mixture, sometimes with a surfactant added as well, is added to the drum as a bleaching solution in order to improve the color, get the hide whiter, and get a uniform surface structure. In addition, titanium dioxide may also be added to the bleaching solution, depending upon the rawhide quality and the facility's processing. In the bleaching step, the rawhide in the drum is soaked with the bleaching solution and rotated for 2.5 to 3 hours. The bleaching solution is then drained from the drum and clean water is added to the drum. The drum is then drained.

The next step for carrying out the method of the invention is adding an acid in order to open the pores of the hide. In this process, an acid is mixed with water in order to form an acid solution and will be added to the hide in order to adjust the pH level of the hide. This has the effect of opening the pores in the hide. The acid could be an acid selected from formic acid, sulfuric acid and muriatic acid or other such acids of this type. For the inventive purpose, the acid is added in order to adjust the pH to a level of the hide between about 6 and 10, and preferably between about 7 and 9. The acid solution is then drained off and the hide is rinsed with clear water to remove the acid, but which leave the pores open. The clear water is then drained off.

The next step of the inventive process is infusing or marinating. Soluble additives are added at this point in the overall process in order to enhance the penetration of these ingredients into the hide product. This is because the pH of the hide, as a result of adding the acid just before infusion, is controlled to between about 6 and 10, preferably between about 7 and 9.

Controlling the pH has the effect of opening up and keeping the pores of the rawhide open, thereby enabling flavor, color, or other additives to better penetrate into the rawhide. In this step, the rawhide is soaked in a bath solution of additives and the bath solution and rawhide is then agitated such as by rotation. Such mechanical processing will help to enhance penetration of the additives into the open fibers of the hide.

Additives include flavors, such as meat flavors, and colors for chew chips and other pet products. Generally, food flavors may include natural ingredients such as meats and meat byproducts derived from poultry, beef, pork, lamb, smoke and other materials, including flavor enhancers and/or artificial flavors commonly used as flavor foods. Food flavors are used at a level of 0.25% to 1.5% of the bath solution, depending on the desired palatability of the finished product. Food colors are typically separate additives, or the flavor ingredients may have coloring characteristics as well, in which case separate color ingredients may not be required. The colorants may be natural or artificial colorants. For example, a smoke flavor also provides color to the final product. The colorants are used at levels of 0.01% to 1.0% of the bath solution, depending on the desired color of the final product.

Other types of additives include powders, vitamins and functional nutritional compounds such as glucosomine, fatty acids, polyphenols, etc..

In carrying out the infusing/marinating step of the present invention, the infusing bath solution is prepared by adding the selected additives to water and then mixed thoroughly until the solution is uniform. The solution is poured into the drum with the hide already in the drum The hide and infusing solution are then exposed to mechanical agitation, for a sufficient time (preferably in the range of between 45 and 60 minutes) to allow the additive ingredients to infuse the hide thoroughly.

After infusion, the solution from the drum is drained. At this juncture, a solution containing a surfactant and preferably a bactericide is added to the drum with the hide in order to render the surface of the hide smooth, to close the pores so that the infused additives remain within the hide, and to ensure that the rawhide is microbiological safe. The drum is then rotated for approximately 60 minutes. The surfactant/bactericide solution in the drum is then drained. Clean water is then added to the drum to remove the bactericide/surfactant solution. The drum is then drained and the hide removed from the drum.

The next step of the process of the invention is to cut the infused/marinated rawhide into desired pieces of various shapes and sizes, as for example shown and described in U.S. Pat. No. 6,935,275 (hereby incorporated by reference).

The next step of the inventive process is to dry the hide pieces using standard drying techniques. For example, the flavored hide pieces can be deposited on a tray and inserted in an oven where they are kept for up to seven days at 35-85° C.

The last step in the inventive method is to package the dried hide pieces for distribution and sale.

In summary, in accordance with the invention, an animal hide is infused with additives during the normal cleaning process and then cut and dried in order to form an animal hide chew. The inventive process allows the additives to be applied to a hide product in an efficient, uniform and consistent way.

While the invention has been described with reference to one or more embodiments, it is to be understood that these embodiments are merely illustrative of the principles of the invention. Accordingly, the embodiments described herein should be considered as exemplary, and not limiting.

1. A method of making a pet chew comprising the steps of:
1. preparing a clean hide by processing an animal skin;
2. treating the hide with an acid in order to adjust the pH of the hide to between about 6 and 10 and thereby open the hide pores;
3. infusing the treated hide with a soluble additive;
4. treating the hide with a surfactant in order to close the hide pores; and
5. cutting and drying the hide in order to form said pet chew.

2. The method of claim 1, wherein the acid is selected from the group consisting of formic acid, sulfuric acid and muriatic acid.

3. The method of claim 1, wherein the additive is selected from the group consisting of flavors, colorants, vitamins and functional nutritional compounds.

4. The method of claim 1, wherein said preparing step includes liming, de-liming and bleaching.

5. The method of claim 1, wherein the hide is selected from the group consisting of rawhide and pig hide.

6. The method of claim 1, wherein the infusing step includes:
preparing a solution comprising mixing said soluble additives with water,
adding said solution to the hide; and
agitating said hide and said solution together.

7. The method of claim 6, wherein said mixing step comprises mechanical agitation.
